(19) United States
(12) Patent Application Publication
(10) Pub. No.: US 2020/0036962 A1
(43) Pub. Date: Jan. 30, 2020

(54) MIXED REALITY GLASSES WHICH DISPLAY VIRTUAL OBJECTS THAT MOVE NATURALLY THROUGHOUT A COMPLETE FIELD OF VIEW OF A USER

(71) Applicant: Reality Plus Ltd., Kfar Saba (IL)

(72) Inventor: Daniel GRINBERG, Hod Hasharon (IL)

(21) Appl. No.: 16/512,455

(22) Filed: Jul. 16, 2019

Related U.S. Application Data
(60) Provisional application No. 62/711,632, filed on Jul. 30, 2018.

(51) Int. Cl. H04N 13/279; G02B 1/118; G02B 7/34; G02B 7/38; G02B 27/01; G06T 19/00

(52) U.S. Cl. CPC H04N 13/279; G02B 1/118; G06T 19/006; G02B 7/38; G02B 27/0172; G02B 7/346

(57) ABSTRACT

A system enables near eye, see-through display of computer generated images (CGIs) to a user. The system includes see-through projection devices, an IMU device and a processor. The see-through projection devices are mounted within a frame of glasses worn on the head of the user. Each device includes a central field display to project the CGIs within the user's central field of view and a peripheral display to project the CGIs within the rest of a human field of view not including the central field of view. The peripheral display is disposed proximate the user's eye and the central field display is centrally disposed behind the peripheral display. The IMU device is mounted on the glasses to measure where the user's head is facing. The processor splits the CGIs between the central and peripheral displays based on where the virtual object is to be projected into the real world and where the user is facing.

### CROSS REFERENCE TO RELATED APPLICATIONS

This application claims priority from U.S. provisional patent application 62/711,632, filed Jul. 30, 2018, which is incorporated herein by reference.

### FIELD OF THE INVENTION

The present invention relates to augmented reality generally and to mixed reality glasses in particular.

### BACKGROUND OF THE INVENTION

Mobile personal electronics and wearables have become immensely popular around the globe. Augmented reality (AR) glasses are a form of wearable computer where information is displayed onto the glasses, typically using a computer-generated image (CGI) format. With these glasses one can see internet content, movies, TV and video games, or any other digital content. Moving images can be seen by the glasses-wearer, and not by anyone else near the viewer. The technology for providing the images is built into the glasses worn on the head.

As opposed to virtual reality, which replaces the real world with a simulated one, augmented reality supplements a view of the real world with information provided by computer-generated sensory input such as sound, video, graphics or Global Positioning System (GPS) data.

Typically, augmented reality provides digital information about elements in the environment. For example, augmented reality might project sports scores onto the AR glasses while the user is viewing a sports match.

Mixed reality, on the other hand, adds capabilities to virtual objects to understand the real world and the relative position of the user and the virtual objects in the real world, thereby enabling virtual objects (generated as CGIs) to interact with the real world. In other words, artificial information about the environment and its objects can be overlaid on the real world.

### SUMMARY OF THE PRESENT INVENTION

There is therefore provided, in accordance with a preferred embodiment of the present invention, a system which enables near eye, see-through display of computer generated images (CGIs) to a user. The system includes see-through projection devices, an IMU device and a processor. The see-through projection devices are mounted within a frame of glasses worn on the head of the user. Each device includes a central field display to project the CGIs within the user's central field of view and a peripheral display to project the CGIs within the rest of a human field of view not including the central field of view. The peripheral display is disposed proximate the user's eye and the central field display is centrally disposed behind the peripheral display. The IMU device is mounted on the glasses to measure where the user's head is facing. The processor splits the CGIs between the central and peripheral displays based on where the virtual object is to be projected into the real world and where the user is facing.

Moreover, in accordance with a preferred embodiment of the present invention, the central field display includes a waveguide lens and the peripheral display includes a transparent display displaying towards the eyes of the user.

Further, in accordance with a preferred embodiment of the present invention, the peripheral display includes a first optical layer between the transparent display and the eyes of the user. The first optical layer includes a plurality of micro-lenses to focus light from the transparent display to the eyes of the user.

Still further, in accordance with a preferred embodiment of the present invention, the peripheral display includes projection elements and an optical layer outside of the peripheral projection elements to correct defocusing of real world objects by the projection elements.

Moreover, in accordance with a preferred embodiment of the present invention, the processor includes a rotation compensator to generate a display location for the CGIs, wherein the display location compensates for motion of the user's head.

Further, in accordance with a preferred embodiment of the present invention, the processor includes a splitter to split the CGIs according to the display location.

Still further, in accordance with a preferred embodiment of the present invention, the processor includes at least one alignment operator to align display attributes between the central display and the peripheral display.

Moreover, in accordance with a preferred embodiment of the present invention, the processor includes a spatial aligner and a color aligner to correct the spatial and color alignment, respectively, of the portion of the CGIs to be displayed on one of the displays. This may be, for example, the peripheral display.

Further, in accordance with a preferred embodiment of the present invention, the peripheral display is a transparent organic light emitting diode (OLED) display.

There is also provided, in accordance with a preferred embodiment of the present invention, a method for near eye, see-through display of CGIs to a user. The method includes having see-through projection devices mounted on a frame of glasses, the devices having central and peripheral displays, measuring where the user's head is facing using an IMU device mounted on the frame of glasses, splitting the CGIs between the central and peripheral displays based on where the virtual object is to be projected into the real world and where the user is facing; and projecting the split CGIs separately to the see-through projection devices. The projecting includes projecting the CGIs within the user's central field of view and projecting the CGIs within the rest of a human field of view not including the central field of view.

Moreover, in accordance with a preferred embodiment of the present invention, the method additionally includes generating a display location for the CGIs, wherein the display location compensates for a motion of the user's head.

Further, in accordance with a preferred embodiment of the present invention, the splitting includes dividing the CGIs according to the display location.

Still further, in accordance with a preferred embodiment of the present invention, the method additionally includes aligning display attributes between the central display and the peripheral display.

Finally, in accordance with a preferred embodiment of the present invention, the aligning includes correcting the spatial and color alignment of the portion of the CGIs to be displayed on one of the displays.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a prior art illustration of a human vision field of view;

FIG. 2 is an illustration of a near-eye display system for mixed reality, constructed and operative in accordance with a preferred embodiment of the present invention;

FIG. 3 is a pictorial illustration of a computer generated image (CGI) of a train superimposed on a landscape view, useful in understanding the system of FIG. 2;

FIG. 4 is a schematic illustration of one embodiment of a see-through projection device, seen from a top view, useful in the system of FIG. 2;

FIGS. 5A, 5B and 5C are schematic illustrations of an exemplary peripheral field, transparent display which projects to a peripheral field of view, useful in the system of FIG. 2;

FIG. 6 is a schematic illustration of a few exemplary CGI's as displayed on one of the see-through projection devices of FIG. 4;

FIGS. 7A, 7B and 7C are schematic illustrations of the movement of an exemplary CGI of an airplane flying through clouds as it moves between central and peripheral displays of the system of FIG. 2;

FIG. 8 is a block diagram illustration of the operations of a processor of the system of FIG. 2; and

FIG. 9 is an exemplary illustration of an image of colored stripes, useful in calibrating the system of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that, for mixed reality to be accepted by the public, the virtual objects should interact with real world objects “naturally”. However, as Applicant has realized, virtual images will not look real within the real world unless the system projecting them takes into account how the human cognitive perception system works. Otherwise, the human viewer will not ‘believe’ in what s/he is viewing.

To provide a comfortable view, Applicant has realized that virtual objects need to move through the human field of view like real objects do. This may require projecting glasses (or “near eye transparent displays”) that enable the user to see the real world with superimposed virtual images throughout the user's field of view.

As used in prior art augmented reality, near eye projection consists of a method of projecting an image into the retina of a user through waveguide lenses, creating a visual effect perceived by the user as a hologram in the real world. This method is required because the human eye needs a minimum distance for perspective in order to focus. However, as Applicant has realized, this projection method is restricted to a limited field of view (FOV) of the waveguide lenses, and to an accordingly limited display frame of the virtual scene. Applicant has realized that since this FOV is much smaller than the natural human FOV, the virtual object will not seem real to the human viewer.

Applicant has realized that, to project virtual objects throughout a user's complete field of view, the near eye display may be formed of combination glasses, with separate projecting units for a central field of view and a peripheral field of view, both of which are transparent to enable the user to view the real world as well as the projected computer generated images (CGIs). For the central field of view, such glasses may include elements which project the virtual image onto the user's retina, thereby creating an illusion in the user's cognitive system of a hologram in the real world. For the peripheral field of view, the glasses may include elements which do not project directly to the user's retina. Moreover, the glasses may include processing elements which may move virtual objects between the central and peripheral fields of view by changing which element projects them.

In addition, Applicant has realized that for the user's comfort, the eyewear needs to be transparent, light and relatively thin and should be functional both indoors and outdoors.

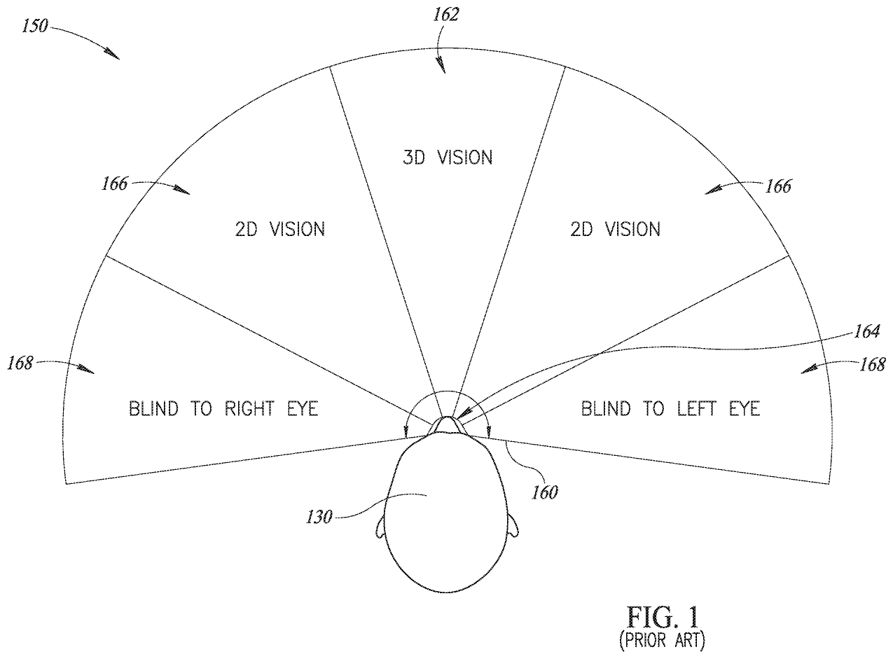

Reference is now made to prior art FIG. 1, which illustrates a human natural field of view 150 about a head 130. As can be seen, the field of view for binocular viewing extends about 200° in the horizontal plane (shown as 160), for both eyes combined. Within this range there is a variety of focus.

As can be seen in FIG. 1, there are multiple sectors to the complete field of view 150. A focus vision sector 162 may be approximately 30° wide, centered on the human nose 164, and is where 3-dimensional vision is perceived, the focus is optimal, and the visual information is very detailed. Within sector 162 there may be multiple subsectors. The most efficient subsector may be 2° wide and may be used for reading. Within a wider subsector, at 6° wide, a person may see, for example, a few words. While 30° may be considered the central field of view, waveguides which provide near eye projection may currently achieve 40° of field of view.

Sectors 166, on each side of sector 162, provide two dimensional vision, in which one eye sees the object outside of focus vision sector 162 and the second eye sees the object at the edge of focus vision sector 162, near the area for the opposite eye. Finally, in sectors 168, to the sides of sectors 166, the object is seen by one eye only. As mentioned hereinabove, the present invention may take this division of field of view 150 into account when projecting visual objects, as CGIs, to the user.

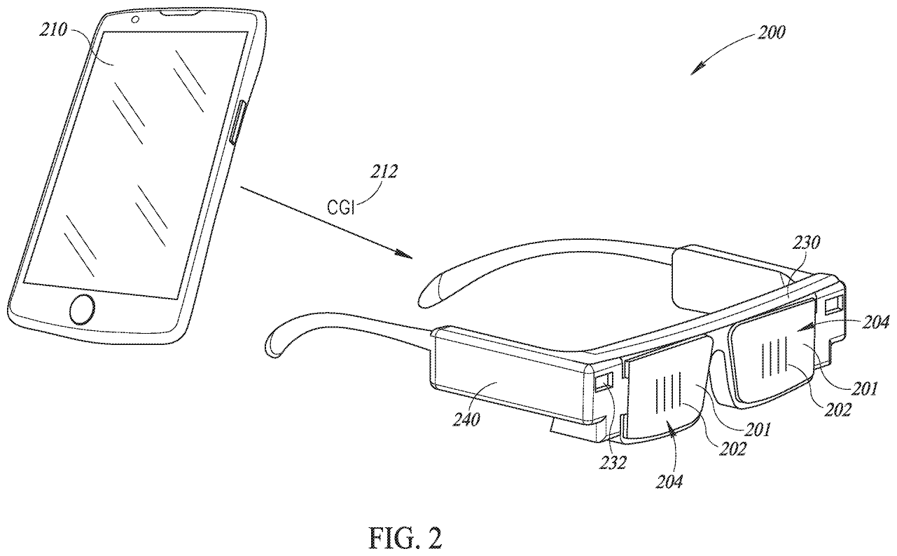

Reference is now made to FIG. 2, which illustrates a near-eye display system 200 for mixed reality utilizing the complete field of view, constructed according to the principles of the present invention. System 200 comprises glasses 230 worn by a user in communication with the user's smartphone 210 or other computing device which may generate a CGI 212. Glasses 230 may comprise a see-through projection device 204 per eye, each of which may comprise a central visual field lens 202, such as a standard, prismatic waveguide lens, and a peripheral field, transparent display (TD) 201 for each eye. Glasses 230 may additionally comprise at least one 3D orientation sensor 232 and an on-glasses computing device 240.

Smartphone 210 may transmit CGI 212 to on-glasses computing device 240, which may split CGI 212 into two images relative to the desired location of the virtual image within the world, one image for central field display 202 and another image for peripheral field TD 201. As discussed in more detail hereinbelow, computing device 240 may correct the initial location of the CGI as received from smartphone 210 to cancel motion and location of the user's head as measured by 3D orientation sensor 232, such as an inertial movement unit (IMU) 232.

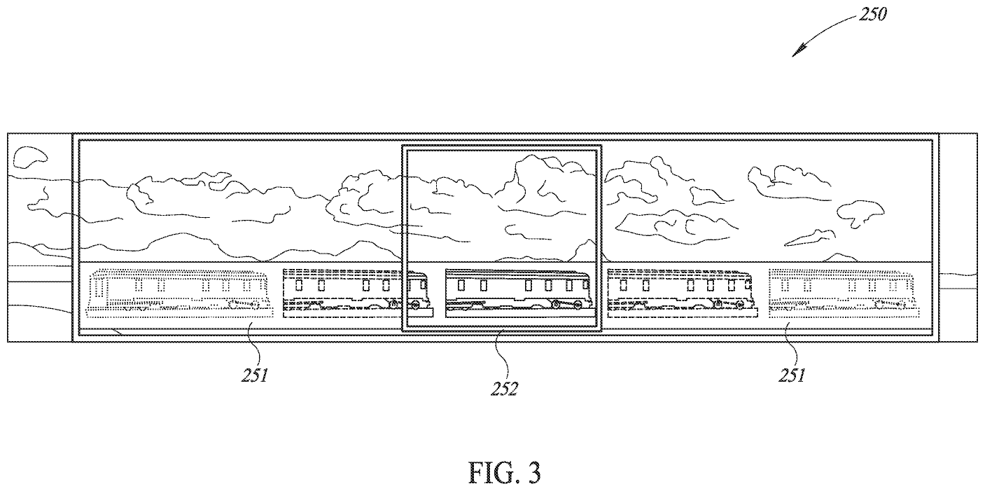

Reference is now briefly made to FIG. 3, which illustrates an image 250 of a CGI train superimposed on a landscape view. Image 250 is divided into 3 sections. A middle section 252 is displayed on central field display 202 while the two external sections 251 are displayed on peripheral field TD 201. Note that middle section 252 is significantly sharper than external sections 251, which are generally defocused. In addition, external sections 251 are gradually defocused, such that the train cars at the very edges are in significantly less focus than the cars closer to middle section 252.

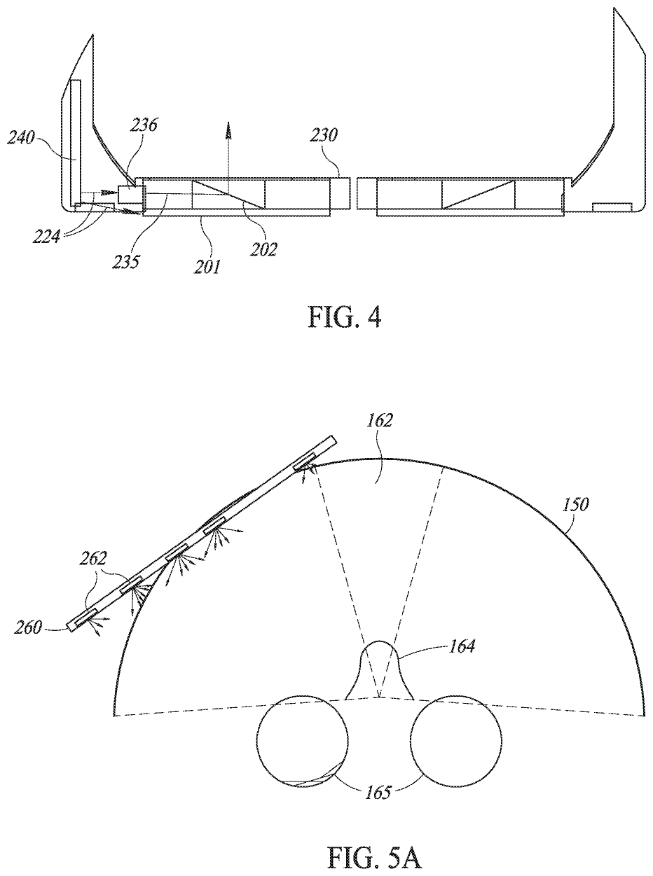

Reference is now made to FIG. 4, which illustrates one embodiment of see-through projection device 204, seen from a top view. In this embodiment, device 204 may comprise a compound lens consisting of two lenses, the one upon the other—one a transparent glass containing the waveguide lens of central visual field lens 202 in the center, and the other the peripheral field, transparent display 201.

As can be seen by arrows 224 of FIG. 4, processor 240 may provide a portion of CGI 212 to a projector 236 and a different portion of CGI 212 to transparent display 201. Projector 236, which may be mounted on the frame of the glasses, may generate the appropriate light beams 235 for its portion of CGI 212 and may project them through the waveguide lens of central visual field lens 202 for each eye. Since the waveguide lens acts as a sophisticated prism, light beams 235 may be refracted from projecting in the direction of the frame of the glasses to projecting towards the user's eye and to focusing it on the user's retina (not shown). The result, as mentioned hereinabove, is that the user may see the virtual object as a hologram. Another way to consider this is that the virtual object is “focused at infinity”.

In addition, processor 240 may provide different versions of CGI 212 to the two devices 204, one to the user's left eye and one to the user's right eye.

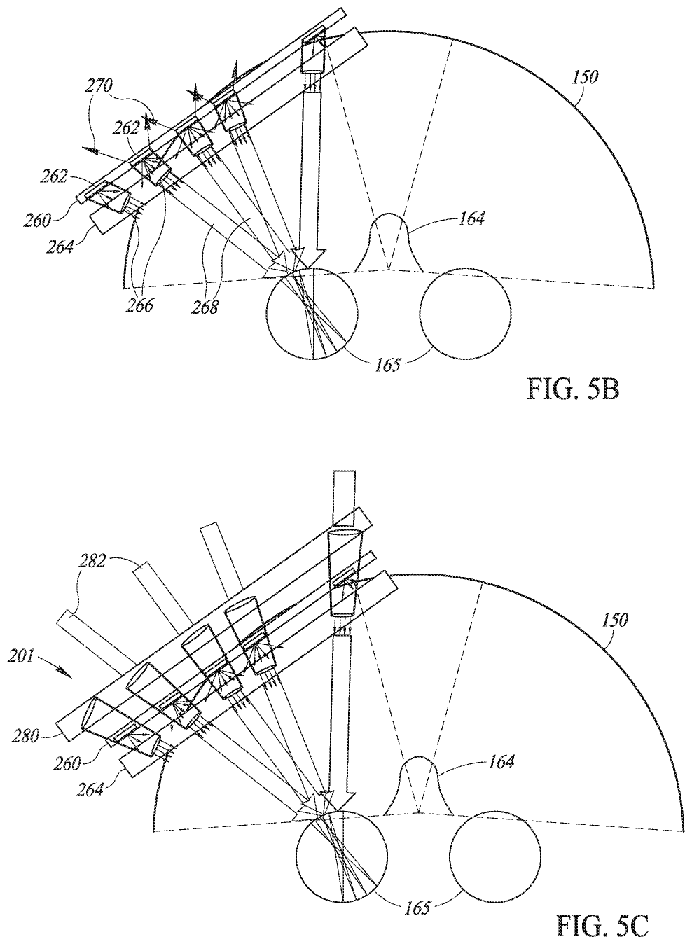

As mentioned hereinabove, central visual field lens 202 does not provide the full human field of view. FIGS. 5A-5C illustrate an exemplary peripheral field, transparent display 201 to project to the rest of the human field of view.

In FIGS. 5A-5C, the full human field of view 150 is shown as an arc spanning about 200°. Central visual field 162 is shown above nose 164 and eyes 165 are shown, located behind nose 164. FIG. 5A shows a peripheral field display for the left eye formed of a simple transparent, near eye electronic display 260 capable of projecting the light of CGI 212, when it is in the periphery, from each of a plurality of pixels 262 towards eyes 165. Display 260 may be transparent, so that the user may be able to see the real world outside of what is being displayed on display 260. For example, display 260 may be formed of TOLED (transparent organic light emitting diode) elements or of transparent liquid crystal display (LCD) elements. Display 260 may be angled to the user's head, as in FIGS. 5A-5C, or straight, as in FIGS. 2 and 4.

Unfortunately, as Applicant has realized, display 260, being a near eye display, is too close to the user's eyes for the user to focus on it. Moreover, the light from these pixels 262 is diffuse and therefore, is not focused onto left eye 165.

FIG. 5B shows the transmission of light when a 1^{st} optical layer 264 is added to simple transparent, near eye display 260, between display 260 and eyes 165. 1^{st} optical layer 264 may be formed of a set of micro-lenses, one per pixel or group of pixels, which may focus the light coming from each pixel 262 towards the retina of the relevant eye 165 (where the left eye is shown for all of FIGS. 5). To this end, each lens may be at a slightly different angle in order to match the location of the pixel with its direction toward the relevant eye 165. As can be seen from arrows 268, the light from near eye display 260 is now focused on eye 165. However, as shown by arrows 270, lenses 266 of 1^{st} optical layer 264 defocus the user's view of the real world (e.g. outside of transparent display 260).

In accordance with a preferred embodiment of the present invention and as shown in FIG. 5C, peripheral field, transparent display 201 may also comprise a 2^{nd} lens array 280, outside of the peripheral projection elements (i.e. transparent display 260 and 1^{st} optical layer 264), to correct the defocusing caused by projection elements 260 and 264 Like 1^{st} optical layer 264, 2^{nd} optical layer 280 may also be formed of a set of micro-lenses, one per pixel. However, for 2^{nd} optical layer 280, the micro-lenses may correct the defocusing of the other elements such that the light from the real world may properly focus onto the user's eye 165, as indicated by arrows 282 which show the light entering display 201 from the real world.

It will be appreciated that transparent display 201 may extend behind central visual field lens 202, as shown in FIG. 4. In this embodiment, none of the pixels 262 which may be behind central visual field lens 202 may be lit up, nor may there be any micro lenses for those pixels.

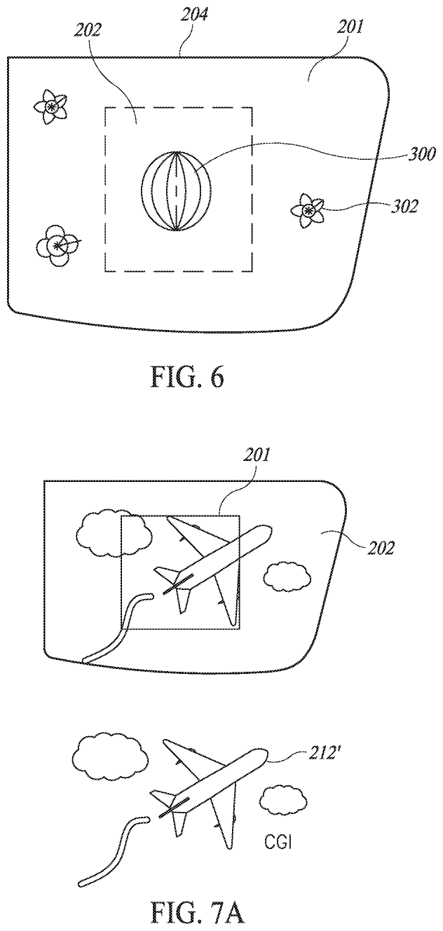

Reference is now made to FIG. 6, which illustrates a few exemplary CGI's 212 as displayed on one of see-through projection devices 204. Recall that central visual field lens 202 may display the virtual object (here it is a sphere 300) on the user's retina, resulting in the user seeing it as a hologram. However, via peripheral field transparent display 201, the user will not view the virtual objects (here shown as multiple flowers 302) clearly.

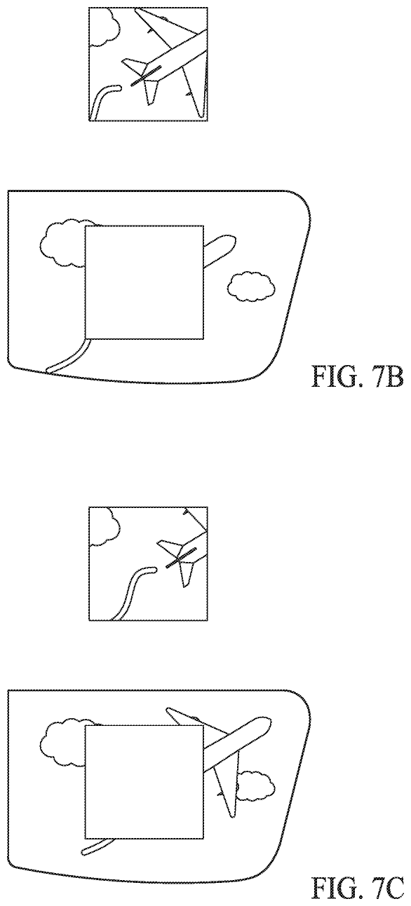

Applicant has realized that, for a mixed reality system to interact with the real world in a natural way, virtual objects 300 and 302 should seem to maintain their locations in space. To do so, system 200 may measure how the user moves his/her head. For example, system 200 may comprise IMU sensor 232 whose data may be utilized to define where the user is looking. Processor 240 may then comprise elements to determine how to move virtual objects 300 and 302 in the ‘opposite’ direction to the motion of the head, as described in more detail hereinbelow, such that virtual objects 300 and 302 appear to remain in their locations in real world. As a result of this and when virtual objects move around, as discussed hereinbelow with respect to FIGS. 7A, 7B and 7C, to which reference is now made, as the user moves his/her head, system 200 may change on which display, 201 or 202, to display virtual objects 300 and 302.

FIGS. 7A, 7B and 7C illustrate the movement of an exemplary CGI, labeled 212′, of an airplane flying through clouds as it moves between displays 201 and 202.

FIG. 7A illustrates exemplary CGI 212′ by itself and displayed over both central field display 202 and to peripheral field display 201. FIG. 7B shows how exemplary CGI 212′ is split between central field display 202 and peripheral display 201. As can be seen, most of the airplane, some of its plume and some of the clouds are displayed on central field display 202 and the remainder of the airplane, clouds and plume are displayed on peripheral display 201.

FIG. 7C shows exemplary CGI 212′ after the airplane has flown a bit. As a result, less of the airplane but more of the plume are displayed on central field display 202 while more of the airplane, along with the clouds which haven't changed location, are displayed on peripheral display 201.

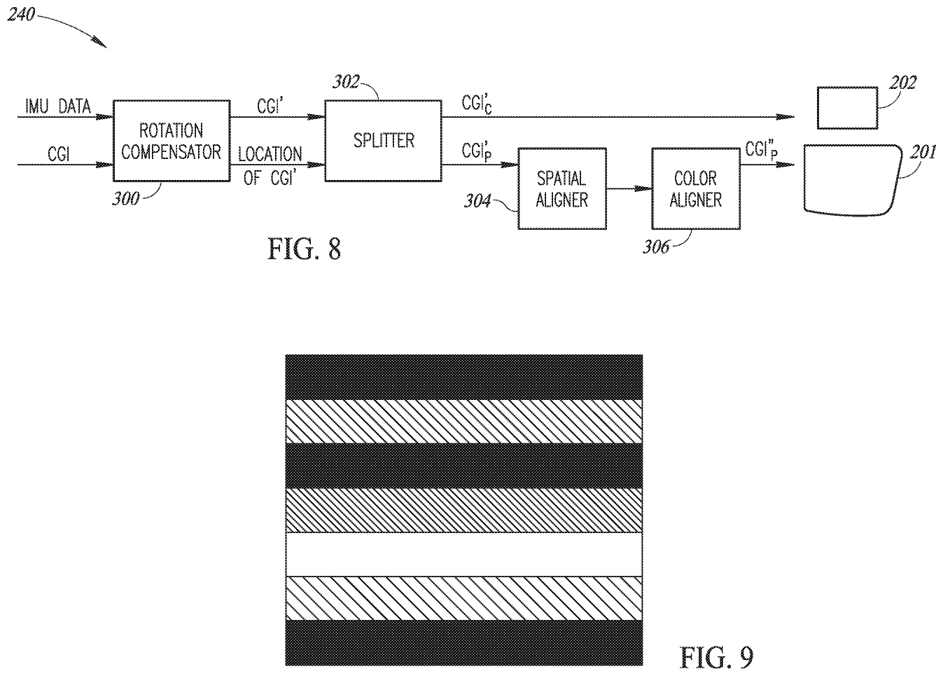

Applicant has realized that switching displays requires handling the changes in the resolution of displays 201 and 202. Reference is now made to FIG. 8 which illustrates the operations of processor 240 to divide each CGI 212 between displays 201 and 202 and to synchronize displays 201 and 202 to each other.

Processor 240 comprises a rotation compensator 300, a splitter 302, and at least one aligner, such as a spatial aligner 304 and a color aligner 306. Rotation compensator 300 may process data from IMU sensor 232 to determine how to move each CGI 212 to match the current location of the user's head. As described in U.S. Pat. No. 9,210,413, assigned to the common assignee of the present application and incorporated herein by reference, CGI 212 may be projected as an inverse movement to the head movement measured by IMU sensor 232. The inverse movement, which may include translation and/or rotation, may be determined, using a known compensation calculation formula, and may be applied to CGI 212 to generate a compensated CGI, labeled CGI′. This may enable the user to perceive the visual object projected by compensated CGI′ 212 as anchored at a certain point in space within the user's field of view.

Splitter 302 may receive compensated CGI′ 212 and its compensated location from rotation compensator 300 and may split CGI′ 212 between displays 201 and 202 as a function of the compensated display location in the real world of the virtual object. Splitter 302 may also generate the two stereoscopic versions of CGI′ 212, one for each eye.

Applicant has realized that the final appearance of CGI′ 212 across the two displays 201 and 202 should be seen to be uniform, continuous and homogeneous. To that end, processor 240 may comprise at least one alignment operator to align display attributes between displays 201 and 202. For example, processor 240 may comprise spatial aligner 304 and color aligner 306.

Spatial aligner 304 and color aligner 306 together may provide alignment of both displays 201 and 202 to each other. As the alignment may be relative, central field display 202 may be set to be the constant display and the parameters of peripheral display 201 may be aligned to match central field display 202 via spatial aligner 304 and color aligner 306. Accordingly, splitter 302 may provide a portion CGI′_{C} to waveguide 202 as is and may provide a portion CGI′_{P} to spatial aligner 304.

Spatial aligner 304 may align curvatures and lines so that they may seem continuous when going from one display to the other. Color aligner 306 may ensure that a given color may appear the same on both displays 201 and 202.

Spatial aligner 304 may utilize a matrix K defining display 202, given by the following equation:

$$K = [ \begin{matrix}f \cdot {m}_{x} & s & {C}_{x} \\ 0 & f \cdot {m}_{y} & {C}_{y} \\ 0 & 0 & 1\end{matrix} ] \qquad Equation 1$$

where f is the focal length of system 200, mₓ, and m_{y} are scale parameters relating pixels to distance, and Cₓ, and C_{y} represent the principle point which is the center of the image. s is a skew parameter between the x and y axes and it is almost always 0 (the x and y axes are usually perpendicular to each other).

The focal length, f, may typically be constant for each system 200. At manufacture, scale parameters (mₓ and m_{y}) and principle points (Cₓ and C_{y}) for peripheral display 201 may be changed to spatially align the particular peripheral display 201 to its associated central field display 202. To do so, a static image may be displayed which may stretch over both displays 201 and 202. A technician may adjust these four parameters for peripheral display 201 until the static image is spatially aligned. At that point, the parameters may be set and spatial aligner 304 may align all incoming CGI′_{P}s.

Spatial aligner 304 may provide its output, a corrected CGI′_{P}, to color aligner 306. Color aligner 306 may comprise a set of color alignment parameters for aligned corrected CGI′_{P}.

At manufacture, an image of colored stripes, such as that shown in FIG. 9, to which reference is now briefly made, may be displayed across displays 201 and 202. FIG. 9 is a grey scale version of a set of 7 differently colored stripes. The stripes should embody a wide range of colors to reasonably cover the color gamut of displays 201 and 202. For example, the stripes may be of red, green, blue, grey, yellow, aqua and purple.

A technician may adjust an appropriate set of parameters to adjust the colors of peripheral display 201 until the colors match the colors in central display 202. The parameters may be defined as follows:

$$[ \begin{matrix}{R}_{final} \\ {G}_{final} \\ {B}_{final}\end{matrix} ] [ \begin{matrix}{C}_{red - red} & {C}_{red - green} & {C}_{red - blue} \\ {C}_{green - red} & {C}_{green - green} & {C}_{green - blue} \\ {C}_{blue - red} & {C}_{blue - green} & {C}_{blue - blue}\end{matrix} ] \cdot [ \begin{matrix}{R}_{initial} \\ {G}_{initial} \\ {B}_{initial}\end{matrix} ] + [ \begin{matrix}{R}_{base} \\ {G}_{base} \\ {B}_{base}\end{matrix} ] \qquad Equation 2$$

In equation 2, R is the red channel, G is the green channel and B is the blue channel, (R,G,B)ᵢₙᵢₜᵢₐₗ are the initial values of peripheral display 201 and (R,G,B)_{final} and its final values. A technician may adjust the initial colors (R,G,B)ᵢₙᵢₜᵢₐₗ by applying some correlation matrix and may also add baseline values to give the final color values. There are total of 12 parameters (9 values Cₓ₋ₓ, in the correlation matrix and 3 baseline values (R,G,B)_{base}) that may be adjusted to optimize the color adjustment. It should be noted that the correlation matrix may be close to the identity matrix and the baseline values may be near zero.

In addition, a non-linear correction may be applied to the intensity of each color channel using the following power law expression, known as “Gamma correction”:

V_{final}=Vᵢₙᵢₜᵢₐₗ^{γ} Equation 3

Once the technician has matched the colors in peripheral display 201, the parameters may be set and color aligner 306 may correct the colors of all CGI′_{P}s produced by spatial aligner 304 and may provide a corrected CGI″_{P} to peripheral display 201.

It will be appreciated that processor 240 may provide other alignments as well. For example, processor 240 may include a flicker aligner (not shown), operative at manufacture, to balance the flicker of peripheral display 201 with the flicker of central display 202. The flicker aligner may change the refresh rate of display 201 until it matches the refresh rate of display 202.

It will be appreciated that processor 240 may comprise other elements to synchronize the image display between central field display 202 and peripheral display 201. The result may be an efficient and satisfying comprehensive virtual image superimposed on reality, and therefore an efficient and satisfying integrated, full range visual scenario of reality and the CGI.

It will be appreciated that the final CGI 212 to be displayed in peripheral display 201 may be equal in size relative to the image projected to infinity by central display 202. Since the size of the image projected to infinity is given, the relative projection size to peripheral display 201 may be provided by the simple and consistent formula of Equation 1.

It will be appreciated that system 200 may project CGIs within a wide FOV, thereby to match the FOV that a human user views. Moreover, within this wide FOV, virtual objects may move fluidly from the different sectors of the human FOV to approximate a natural motion.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing infrastructure or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), field-programmable gate array (FPGA), application-specific integrated circuit (AISC), system on chip (SOC), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages, frameworks or technologies may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system enabling near eye, see-through display of computer generated images (CGIs) to a user, the system comprising:
see-through projection devices mounted within a frame of glasses worn on the head of the user, each the device comprising:
a central field display to project the CGIs within the user's central field of view; and
a peripheral display to project the CGIs within the rest of a human field of view not including the central field of view,
wherein the peripheral display is disposed proximate the user's eye and the central field display is centrally disposed behind the peripheral display;
an IMU device mounted on the glasses to measure where the user's head is facing; and
a processor to split the CGIs between the central and peripheral displays based on where the virtual object is to be projected into the real world and where the user is facing.

2. The system of claim 1 wherein the central field display comprises a waveguide lens.

3. The system of claim 1 wherein the peripheral display comprises a transparent display displaying towards the eyes of the user.

4. The system of claim 1 wherein the peripheral display comprises a first optical layer between the transparent display and the eyes of the user, the first optical layer comprising a plurality of micro-lenses to focus light from the transparent display to the eyes of the user.

5. The system of claim 2 wherein the peripheral display comprises projection elements and an optical layer outside of the peripheral projection elements to correct defocusing of real world objects by the projection elements.

6. The system of claim 1 and wherein the processor comprises a rotation compensator to generate a display location for the CGIs, wherein the display location compensates for motion of the user's head.

7. The system of claim 6 and wherein the processor comprises a splitter to split the CGIs according to the display location.

8. The system of claim 7 and wherein the processor comprises at least one alignment operator to align display attributes between the central display and the peripheral display.

9. The system of claim 8 and wherein the processor comprises a spatial aligner and a color aligner to correct the spatial and color alignment, respectively, of the portion of the CGIs to be displayed on one of the displays.

10. The system of claim 9 and wherein the one of the displays is the peripheral display.

11. The system of claim 1 and wherein the peripheral display is a transparent organic light emitting diode (OLED) display.

12. A method for near eye, see-through display of CGIs to a user, the method comprising:
having see-through projection devices mounted on a frame of glasses, the devices having central and peripheral displays;
measuring where the user's head is facing using an IMU device mounted on the frame of glasses;
splitting the CGIs between the central and peripheral displays based on where the virtual object is to be projected into the real world and where the user is facing; and
projecting the split CGIs separately to the see-through projection devices, the projecting comprising:
projecting the CGIs within the user's central field of view; and
projecting the CGIs within the rest of a human field of view not including the central field of view.

13. The method of claim 12 and additionally comprising generating a display location for the CGIs, wherein the display location compensates for a motion of the user's head.

14. The method of claim 13 and wherein the splitting comprising dividing the CGIs according to the display location.

15. The method of claim 14 and additionally comprising aligning display attributes between the central display and the peripheral display.

16. The method of claim 15 and wherein the aligning comprises correcting the spatial and color alignment of the portion of the CGIs to be displayed on one of the displays.
